(19) United States
(12) Patent Application Publication
(10) Pub. No.: US 2026/0099438 A1
(43) Pub. Date: Apr. 9, 2026

(54) STORAGE METHOD FOR MIXED PRECISION WEIGHTS IN NEURAL NETWORKS

(71) Applicant: Keysight Technologies Singapore (Sales) Pte. Ltd., Yishun (SG)

(72) Inventors: Geert VERBRUGGEN, Yishun (SG); Bart GYBELS, Yishun (SG); Gert BEHIELS, Yishun (SG); Yrjo KOYEN, Yishun (SG)

(73) Assignee: Keysight Technologies Singapore (Sales) Pte. Ltd., Yishun (SG)

(21) Appl. No.: 18/911,034

(22) Filed: Oct. 9, 2024

(51) Int. Cl. G06F 12/02

(52) U.S. Cl. CPC G06F 12/023

(57) ABSTRACT

The present invention concerns a method for processing a plurality of weights with a weight bit size of a layer of an artificial neural network in a destination memory with a memory width. The original location of the weight data may be another memory, likely, an external memory, while the destination memory is an internal memory provided with at least one processing pipeline. The method permits the transfer of data, in particular, weights of a neural network model, from a low speed memory to a high speed memory such that said data is stored in the high speed destination memory in such a disposition that makes simultaneous access to a plurality of weights both faster and more efficient.

### FIELD OF THE INVENTION

The present invention relates to a method for improving data storage and access architecture.

### BACKGROUND

US2018082181 discloses a neural network reordering, weight compression, and processing. In the method disclosed in US '181, a neural network is trained to generate feature maps and associated weights. Reordering is performed to generate a functionally equivalent network. The reordering may be performed to improve at least one of compression of the weights, load balancing, and execution. In one implementation, zero value weights are grouped, permitting them to be skipped during execution.

The present invention aims to resolve at least some of the problems and disadvantages mentioned above. The aim of the invention is to provide a method which eliminates those disadvantages. The present invention targets at solving at least one of the aforementioned disadvantages.

### SUMMARY OF THE INVENTION

The present invention and embodiments thereof serve to provide a solution to one or more of above-mentioned disadvantages. To this end, the present invention relates to a method for processing a plurality of weights with a weight bit size of a layer of an artificial neural network in a destination memory with a memory width according to claim 1.

Preferred embodiments of the device are shown in any of the claims 2 to 18. A specific preferred embodiment relates to an invention according to claim 11. In this embodiment, at least one of a plurality of shift registers used to store and read weight data is a dynamic shift register configured to change the number of bits it stores according to the bit size of the weight being processed by the output processing pipeline. This permits processing weights having a non-constant bit size.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows weight storage for 8-bit weights in a 32-it wide memory.

FIG. 2 shows an example for 6-bit weights, where each weight is padded to eight bits.

FIG. 3 show a memory where multiple weights in a single memory word.

FIG. 4 shows how the weights are read and reconstructed from memory in a processing unit.

### DETAILED DESCRIPTION OF THE INVENTION

The present invention concerns a method for processing a plurality of weights with a weight bit size of a layer of an artificial neural network in a destination memory with a memory width. The original location of the weight data may be another memory, likely, an external memory, while the destination memory is an internal memory provided with at least one processing pipeline. The method permits the transfer of data, in particular, weights of a neural network model, from a low speed memory to a high speed memory such that said data is stored in the high speed destination memory in such a disposition that makes simultaneous access to a plurality of weights both faster and more efficient. This increase in access speed to weight data has the advantage of greatly accelerating neural network inference speed, while reducing energy consumption of any device where the method according to the present invention is applied.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about”refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention provides a method for processing a plurality of weights with a weight bit size of a layer of an artificial neural network in a destination memory with a memory width, the method comprising the step of processing the weights, and the step of storing said processed weights in the destination memory. The weights are obtained by first training the artificial neural network. By preference the weights are obtained by sufficiently training the neural network, such that inference carried out using said neural network yields a high level of reliability, said reliability being preferably above 70%, more preferably above 75%, 80%, 85%, 90%, 95%, 97%, 98%, 98.5%, 99%, 99.5%,99.6%, most preferably above 99.7%. The destination memory is preferably an internal memory. The source memory may be any kind of memory, such as an internal memory, but more preferably, an external memory. In this way, a larger external memory may be used in order to provide the weights, which are then stored in a smaller internal memory, thereby allowing for the weights in said internal memory to be accessed with a higher bandwidth, therefore, faster than directly accessing an external memory.

Artificial neural networks (ANNs, also shortened to neural networks (NNs) or neural nets) are a branch of machine learning models that are built using principles of neuronal organization. An ANN is based on a collection of connected units or nodes called artificial neurons, which loosely model the neurons in a biological brain. Each connection, like the synapses in a biological brain, can transmit a signal to other neurons. An artificial neuron receives signals then processes them and can signal neurons connected to it. The “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold.

In order to facilitate the implementation of a neural network in an integrated circuit, preferably an application specific integrated circuit, the weight of the neural network may be quantized. In this way, the memory requirements of a device directed at performing said inference are advantageously reduced, which further, advantageously, permits reducing energy consumption of the device. This is particularly advantageous when said inference is to be carried out by portable devices, in which devices, being typically battery powered, energy saving means longer operational service before recharging.

In this context, inference or deep learning inference is the phase in development where the capabilities learned during training of a neural network is put to work. The trained neural networks make predictions, or inferences, on new, or novel, data that the model has never seen before.

In this context, quantization is the process of reducing the precision of the weights, biases, and activations such that they consume less memory.

The step of processing the weights comprises the step of: dividing each weight into at least two separate weight slices with a fixed bit size for each weight, said fixed bit sizes preferably being equal for each weight slice, each comprising one or more bits and together defining the weight.

The step of storing the processed weights comprises the step of storing each n-th separate weight slice of the weights sequentially into the destination memory. Here, n runs from 1 to the number of weight slices per weight, such that each word of the destination memory contains only the m-th weight slices of the weights, wherein m is a number between 1 and the number of weight slices per weight. In this way, it is possible to more fully use the available memory and available bus when reading the weights.

In this context, the term bus, shortened form of the Latin omnibus, and historically also called data highway or databus, is to be understood as a communication system that transfers data between components inside a computer, or between computers. This expression covers all related hardware components e.g. wire, optical fiber, etc. and software, including communication protocols.

In this context, the term processing pipeline or data pipeline is to be understood as a set of processes and tools that move data from one system to another, often involving stages of collection, processing, storage, and analysis.

In an embodiment, the weight slices are stored, such that the destination memory comprises a plurality of subsequent words with a width equal to the memory width, wherein the n-th word comprises only n-th weight slices of the weights, wherein n runs from 1 to the number of weight slices per weight. By preference, the storing of the n-th weight slices in the n-th word is performed until the word is filled with n-th weight slices, after which subsequent n-th weight slices are stored in the n+K-th word, wherein K is the number of weight slices per weight, wherein this is repeated by storing subsequent n-th weight slices in the n+κ·(p+1)-th word after filling the n+K⋅p-th word, wherein p is a natural number running from 1 up to a value for which n+Kκ(p+1) is in between ┌(N·B)/W┐−1 and ┌(N·B)/W┐, N being the total number of weights, B being the fixed bit size and W being the memory width. This advantageously permits full use of the available internal memory and of the processing pipelines made available by the bus connecting the internal memory to the processing unit making use of the weights stored in said internal memory.

In an embodiment, the weight slice bit size is determined based on a number of available input processing pipelines, said input processing pipelines configured for the step of processing and/or storing the weights. This ensures that a maximum number of weights can be written simultaneously. In this way the speed at which weights can be accessed and written from the source memory to the destination memory is advantageously increased.

In an embodiment, the weight slice bit size is determined based on the memory width and/or the weight bit size. In this embodiment, the term memory refers to the destination memory. By preference, the steps of processing and storing the weights are performed by a number of input processing pipelines, and wherein the number of input processing pipelines is set to be equal to the width of the destination memory. In this way, the number of weights which can be accessed simultaneously from said destination memory is advantageously maximized, further increasing the speed at which a processing unit is able to access the weights.

In an embodiment, each output pipeline comprises a shift register. By preference, each shift register is set to a bit value that is equal to the bit size of the weight assigned to its corresponding output processing pipeline. In this way, multiple weights can be assigned to the same processing pipeline as the sift register first collects all bits of each weight before transferring said bits to a processing unit and restarting with the collection of the bits of a subsequent weight.

In an embodiment, at least one of the shift registers is a dynamic shift register configured to change the number of bits it stores according to the bit size of the weight being processed by the output processing pipeline. By preference, each weight is stored in the destination memory together with its corresponding shift register value. In this way, weights having a non-constant bit size can still be processed.

In an embodiment, during each clock cycle, each input processing pipeline stores in the destination memory one bit slice of the weight assigned to it. By preference, a new weight is assigned to an input processing pipeline every time the number of clock cycles carried out by said processing pipeline reaches the set value of the shift register assigned to its output pipeline.

In an embodiment, the shift register is dimensioned according to the largest weight bit size supported by the processing pipeline, each weight having a bit size below the largest weight bit size is padded before being stored in the destination memory. This guarantees that all the weight bit sizes can be accommodated by the shift register, thereby preventing any processing pipeline breakage errors.

A second aspect of the invention provides a method for reconstructing weights of a neural network from a destination memory, said weights having a known weight bit size, said destination memory having a known memory width and comprising a known number of words, and each of said weights having been stored in at least two separate weight slices with a known slice bit size for each weight slice, said weights preferably stored using the method of claim 1, the method for reconstructing weights comprising the step of:
in each n-th word of the destination memory, dividing the n-th word in separate, subsequent word slices with a bit size equal to the n-th weight slice bit size, wherein said step is repeated for n running from 1 up to the number of words in steps of 1;
reconstructing each m-th weight by concatenating the m-th word slice of each word in the destination memory to which the m-th weight is associated, wherein said step is repeated for m running from 1 up to the number of weights in steps of 1.

In an embodiment, the reconstruction of each m-th weight is achieved by concatenating the m-th word slice of κ subsequent words, with κ being the number of weight slices per weight, and wherein the last of the κ subsequent words is the K·p-th word, wherein p is a natural number such that K·p is at most the total number of words in the destination memory. By preference, a plurality of shift registers is used in order to perform said concatenation. More preferably, said shift registers are dynamic shift registers. This advantageously permits the reconstruction of weights having fixed bit size but also weights having variable bit sizes.

In an embodiment, each shift register has serial output. This advantageously permits reducing wiring complexity and thus the risk of errors in printed circuit boards. Furthermore, serial output shift registers typically have a smaller footprint, allowing them to be used in smaller devices.

In an embodiment, each shift register has parallel outputs, the number of outputs being the same size as the shift register. In this way, high speed data transfer is advantageously made possible.

In an embodiment, each shift register is a universal shift register. In this context, an universal shift register is to be understood a shift register which can perform input output operations in both serial and parallel modes. This permits taking advantage of the capabilities of both parallel out and serial out shift registers, as well as, allowing for the communication with devices and/or elements requiring either serial or parallel input.

However, it is obvious that the invention is not limited to this application. The method according to the invention can be applied in all sorts of devices requiring high speed memory access.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES AND DESCRIPTION OF FIGURES

With as a goal illustrating better the properties of the invention the following presents, as an example and limiting in no way other potential applications, a description of a number of preferred applications of the method for processing a plurality of weights based on the invention, wherein:

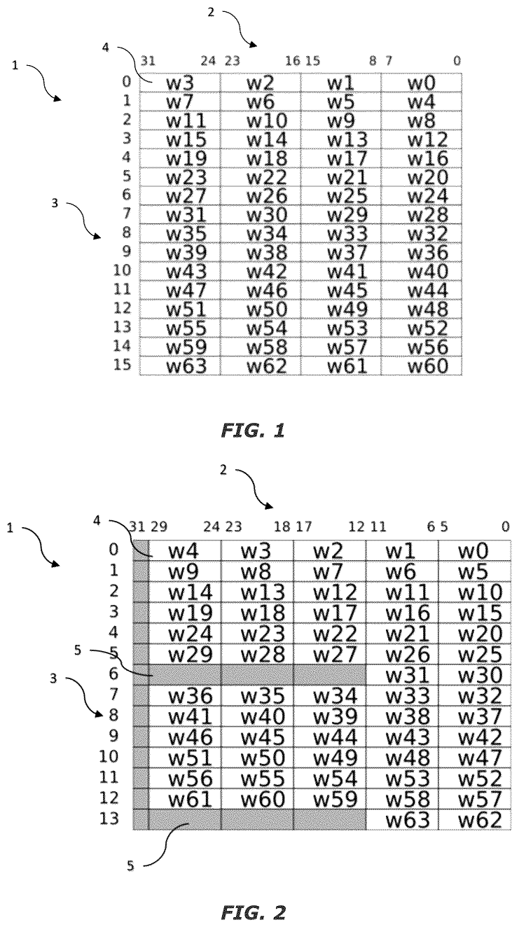

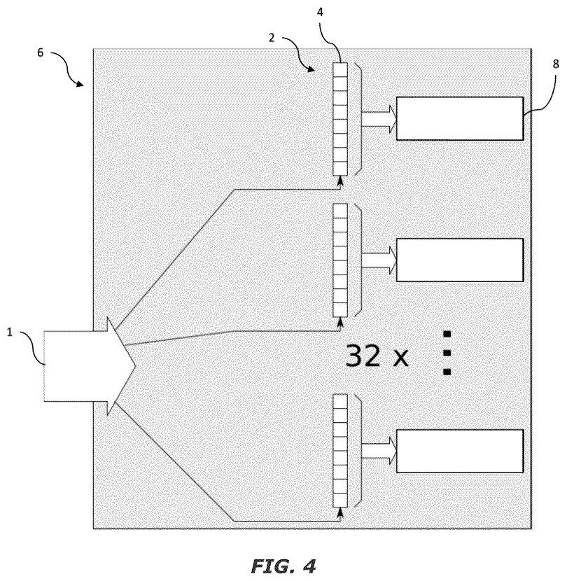

FIG. 1 shows weight storage for 8-bit weights (4) in a 32-bit wide memory (1). In neural networks, weights are typically used in blocks. FIG. 1 shows an example of how the weights (4) can be stored in memory (1). In this example, weights are stored efficiently: there are no gaps in the memory utilization, and a minimal set of word reads is needed to fetch the full set of 64 weights. The memory (1) is divided into eight bit words ordered by means of a plurality of words addresses (3), each address comprising thirty two bits (2) grouped in four words of eight bit each. Typically, a processing unit (6 not shown) reads the weights from memory. The weights fetched in parallel in each of the four data words, as sown in data word are fed into separate processing pipelines (8). This is further illustrated FIG. 4.

FIG. 2 shows an example for 6-bit weights (4), where each weight is padded to eight bits. These eight bits correspond to the size of each data word, wherein each weight (4) is stored. When the encoded weights (4) size is not a divisor of the memory (1) width, efficient storage becomes less trivial. This is due to the discrepancy between the word size and the bit size of each weight (4).

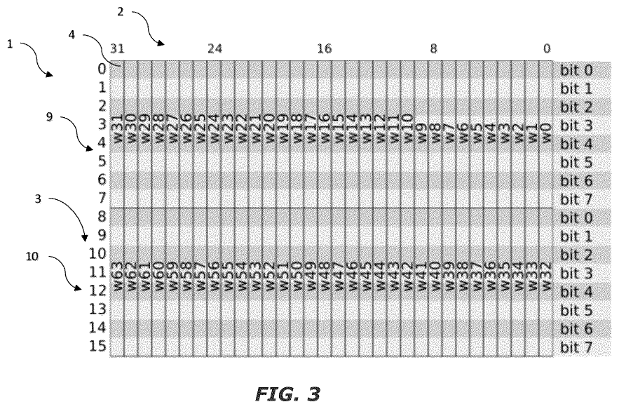

FIG. 3 show a memory (1) where multiple weights (4) in a single memory word. Each word comprises a single of a series of thirty two weights, each group of thirty two weights corresponding to a block (9, 10). For each block (9, 10), the figure shows the first word comprising the first bit of each of thirty two weights (4), and each subsequent word of the same block (9 or 10) comprising a subsequent bit of the same thirty two weights (4). As such, the number of words required, corresponds to the weight (4) size in bits. The figure also shows a second block (10) comprising another set of thirty two weights (4) stored in eight words of thirty two bits each.

FIG. 4 shows how the weights (4) are read and reconstructed from memory (1) in a processing unit (6). The memory (1) width is set equal to the number of processing pipelines (8), which are thirty two in this example. Each processing pipeline is preceded by a shift register (not shown), connected to a single bit of the data coming from the memory (1). When data is arriving from the memory (1), they are shifted into the respective shift registers. When all the bits of a series of weights (4) are read in the correct order, each shift register will contain all bits belonging to a single weight (4) value. The shift register itself is dimensioned to the largest weight (4) size supported by the processing pipeline.

Therefore, before starting to shift, an initialization of the shift register is required to have a known value for the bits that are not updated by the shift. Adapting to a different weight size only involves loading a different counter value in the state machine that generates the read accesses to the memory, and that decides when all bits are shifted, and can be passed to the processing pipeline (8).

The present invention is in no way limited to the given examples or to the embodiments presented in the figures. On the contrary, methods according to the present invention may be realized in many different ways without departing from the scope of the invention.

It is supposed that the present invention is not restricted to any form of realization described previously and that some modifications can be added to the presented example without reappraisal of the appended claims. For example, the present invention has been described referring to artificial neural network weights, but it is clear that the invention can be applied to other forms of data requiring efficient storage and retrieval, for instance.

1. A method for processing a plurality of weights with a weight bit size of a layer of an artificial neural network in a destination memory with a memory width, the method comprising the steps of:
processing the weights;
storing said processed weights in the destination memory
wherein the step of processing the weights comprises the step of:
dividing each weight into at least two separate weight slices with a fixed bit size for each weight, said fixed bit sizes preferably being equal for each weight slice, each comprising one or more bits and together defining the weight;
and in that the step of storing said processed weights comprises the step of:
storing each n-th separate weight slice of the weights sequentially into the destination memory, wherein n runs from 1 to the number of weight slices per weight, such that each word of the destination memory contains only the m-th weight slices of the weights, wherein m is a number between 1 and the number of weight slices per weight.

2. The method according to claim 1, wherein the weight slices are stored, preferably in order, such that the destination memory comprises a plurality of subsequent words with a width equal to the memory width, wherein the n-th word comprises only n-th weight slices of the weights, wherein n runs from 1 to the number of weight slices per weight.

3. The method according to claim 1, wherein the storing of the n-th weight slices in the n-th word is performed until the word is filled with n-th weight slices, after which subsequent n-th weight slices are stored in the n+κ-th word, wherein κ is the number of weight slices per weight, wherein this is repeated by storing subsequent n-th weight slices in the n+K·(p+1)-th word after filling the n+κ·p-th word, wherein p is a natural number running from 1 up to a value for which n+κ·(p+1) is in between ┌(N·B)/W┐−1 and ┌(N·B)/W┐, N being the total number of weights, B being the fixed bit size and W being the memory width.

4. The method according to claim 1, wherein the weight slice bit size is determined based on a number of available input processing pipelines, said input processing pipelines configured for the step of processing and/or storing the weights.

5. The method according to claim 1, wherein the weight slice bit size is determined based on the memory width and/or the weight bit size.

6. The method according to claim 1, wherein the steps of processing and storing the weights are performed by a number of input processing pipelines, and wherein the number of input processing pipelines is set to be equal to the width of the destination memory.

7. The method according to the preceding claim 6, wherein each output pipeline comprises a shift register.

8. The method according to the preceding claim 7, wherein each shift register is set to a bit value that is equal to the bit size of the weight assigned to its corresponding output processing pipeline.

9. The method according to claim 1, wherein during each clock cycle, each input processing pipeline stores in the destination memory one bit slice of the weight assigned to it.

10. The method according to claim 1, wherein a new weight is assigned to an input processing pipeline every time the number of clock cycles carried out by said processing pipeline reaches the set value of the shift register assigned to its output pipeline.

11. The method according to claim 7, wherein at least one of the shift registers is a dynamic shift register configured to change the number of bits it stores according to the bit size of the weight being processed by the output processing pipeline.

12. The method according to claim 7, wherein each weight is stored in the destination memory together with its corresponding shift register value.

13. The method according to claim 7, wherein the shift register is dimensioned according to the largest weight bit size supported by the processing pipeline, each weight having a bit size below the largest weight bit size is padded before being stored in the destination memory.

14. A method for reconstructing weights of a neural network from a destination memory, said weights having a known weight bit size, said destination memory having a known memory width and comprising a known number of words, and each of said weights having been stored in at least two separate weight slices with a known slice bit size for each weight slice, said weights preferably stored using the method of claim 1, the method for reconstructing weights comprising the step of:
in each n-th word of the destination memory, dividing the n-th word in separate, subsequent word slices with a bit size equal to the n-th weight slice bit size, wherein said step is repeated for n running from 1 up to the number of words in steps of 1;
reconstructing each m-th weight by concatenating the m-th word slice of each word in the destination memory to which the m-th weight is associated, wherein said step is repeated for m running from 1 up to the number of weights in steps of 1.

15. The method according to claim 14, wherein the reconstruction of each m-th weight is achieved by concatenating the m-th word slice of κ subsequent words, with κ being the number of weight slices per weight, and wherein the last of the κ subsequent words is the κ p-th word, wherein p is a natural number such that κ·p is at most the total number of words in the destination memory.

16. The method according to claim 14, wherein each shift register has serial output.

17. The method according to claim 14, wherein each shift register has parallel outputs, the number of outputs being the same size as the shift register.

18. The method according to claim 14, wherein each shift register is a universal shift register.
